(19) United States
(12) Patent Application Publication
(10) Pub. No.: US 2023/0336557 A1
(43) Pub. Date: Oct. 19, 2023

(54) RESOURCE ALLOCATING AND MANAGEMENT IN A COMPUTER NETWORK

(71) Applicant: Bank of America Corporation, Charlotte, NC (US)

(72) Inventors: Jennifer Dawn Frato, Morristown, NJ (US); Angela B. Shoff, Danville, VA (US); Aristotle Qutami, Oak Park, CA (US); Melissa L. Miller, Charlotte, NC (US); Brad Alan Martone, Charlotte, NC (US); Caroline Amary Alcindor, Brooklyn, NY (US); Andrew Joseph Hubschman, Cornelius, NC (US); Bhargavi Tippareddy, Edison, NJ (US); William J. Burgess, Concord, NC (US); Floyd E. McDowell, Wilmington, DE (US); Ronald M. Vanderwey, Charleston, SC (US); Ryan David Watts, Charlotte, NC (US)

(21) Appl. No.: 17/721,984

(22) Filed: Apr. 15, 2022

(51) Int. Cl. H04L 9/40

(52) U.S. Cl. CPC H04L 63/102; H04L 63/108

(57) ABSTRACT

A device is configured to receive a resource request that identifies a first user, a first resource that is currently assigned to the first user, and a second resource that the first user is requesting. The device is further configured to obtain information for the first resource and to determine whether the first user qualifies for the second resource based on the information associated with the first resource and resource allocation requirements for the second resource. The device is further configured to obtain the first resource from the first user and to associate the second resource with the first user for a predetermined period of time. The device is further configured to determine the first user has returned the second resource within the predetermined period of time, to remove the association between the second resource and the first user, and to release the first resource to the first user.

### TECHNICAL FIELD

The present disclosure relates generally to resource management for a computer network, and more specifically to resource allocating and management in a computer network.

### BACKGROUND

Existing computer systems may be configured to allocate resources (e.g. hardware resources and/or software resources) to the users of network devices within the system. A computer system may temporarily allocate resources to the user of a network device so that the user can perform some kind of operation or task. Managing and allocating a system's resources poses a technical challenge because computer systems have a limited number of resources. In some cases, existing computer systems may be configured to allocate resources based on the information that is provided by a user. Existing computer systems lack the ability to analyze the information provided by a user to determine whether the user is approved for accessing certain resources. In addition, exiting computer systems also lack the ability to analyze information that is associated with any requested resources to determine whether the resources meets the user's needs. In some instances, the user may request more resources than are necessary to meet their needs. In this case, the requested resources are unavailable to other network device users until they are released or returned. This limits a computer system's ability to provide support and resources for other network device users.

### SUMMARY

The disclosed system provides several practical applications and technical advantages that overcome the previously discussed technical problems. The following disclosure provides a practical application of a resource management device for a computer system. The disclosed resource management device provides practical applications that improve the resource utilization and data throughput of a computer system by dynamically allocating and exchanging resources among network device users. This process generally involves using a centralized repository device (i.e. the resource management device) that is configured to track and manage resource allocations among its users. The resource management device is configured to store user information about users and information about the resource allocations among the users of the computer system. This configuration allows information to be stored in a centralized location which improves accessibility to the resource allocation information and prevents redundant data storage which consumes memory resources and may have discrepancies with other instances of the information. This configuration provides a technical advantage by improving resource utilization and management compared to other systems that use a distributed approach where information about resources is stored in various locations. Thus, this process provides improved resource utilization and improved data throughput which improves the overall performance of network devices and the computer system.

In one embodiment, the computer system comprises a resource management device that is configured to receive a resource request that identifies a first user, a first resource that is currently assigned to the first user, and a second resource that the first user is requesting. The device is further configured to obtain information for the first resource and to determine whether the first user qualifies for the second resource based on the information associated with the first resource and resource allocation requirements for the second resource. The device is further configured to obtain the first resource from the first user and to associate the second resource with the first user for a predetermined period of time. The device is further configured to determine the first user has returned the second resource within the predetermined period of time, to remove the association between the second resource and the first user, and to release the first resource to the first user.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in conjunction with the accompanying drawings and detailed description, wherein like reference numerals represent like parts.

FIG. 1 is a schematic diagram for a computer system configured to use a resource management device;

FIG. 2 is a flowchart of an embodiment of a resource allocating process for the computer system; and

FIG. 3 is an embodiment of a resource management device for the computer system.

### DETAILED DESCRIPTION

### Computer System Overview

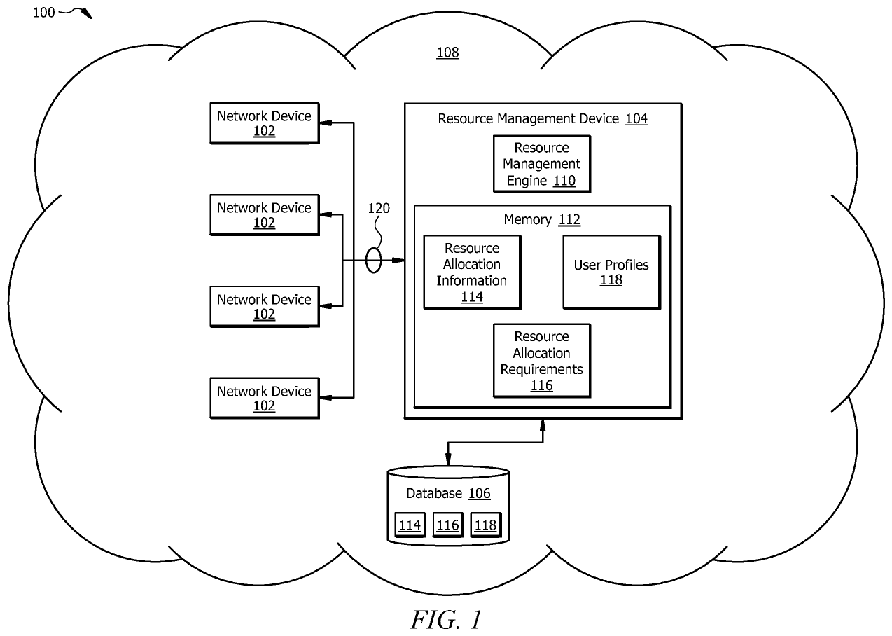

FIG. 1 is a schematic diagram of an embodiment of a computer system 100 that is generally configured to allow users to request access to resources within the computer system 100 by exchanging control of resources that they currently own or associated with. This process involves using a centralized repository (i.e. the resource management device 104) to track and manage resource allocations among its users. This process provides improved resource utilization and management compared to other systems that use a distributed approach where information about resources is stored in multiple locations.

In one embodiment, the computer system 100 comprises one or more network devices 102, a resource management device 104, and a local database 106. The network devices 102, the resource management device 104, and the database 106 are in signal communication with each other within a network 108. The network 108 allows communication between and amongst the various components of the computer system 100. This disclosure contemplates the network 108 being any suitable network operable to facilitate communication between the components of the computer system 100. The network 108 may include any interconnecting system capable of transmitting audio, video, signals, data, messages, or any combination of the preceding. The network 108 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication (NFC) network, a Zigbee network, and/or any other suitable network.

### Network Devices

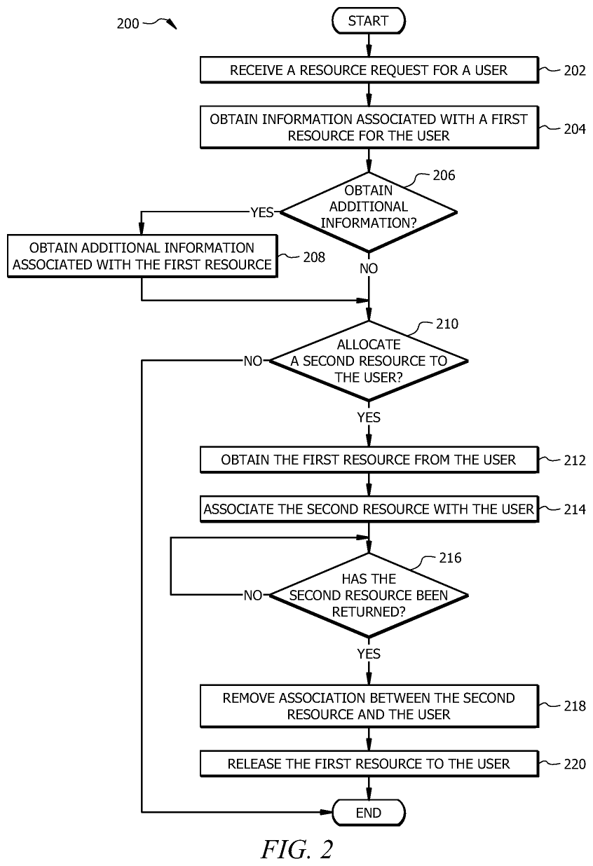

A network device 102 is a hardware device that is generally configured to provide hardware and software resources to a user. Examples of a network device 102 include, but are not limited to, a server, a laptop, a computer, a smartphone, a tablet, a smart device, an Internet-of-Things (IoT) device, or any other suitable type of device. In some embodiments, the network device 102 may comprise a graphical user interface (e.g. a display), a touchscreen, a touchpad, keys, buttons, a mouse, or any other suitable type of hardware that allows a user to view data and/or to provide inputs into the network device 102. Each network device 102 is configured to allow a user or a user's representative to send resource requests 120 to the resource management device 104 to request access to a resource for the user in exchange for another resource. As an example, a user may use a network device 102 to send a resource request 120 that request temporarily exchanging one hardware or software resource for another hardware or software resource. As another example, a user may use the network device 102 to send a resource request 120 that requests temporarily exchanging a physical or digital object for a currency. An example of this process is described in more detail below in FIG. 2.

### Resource Management Device

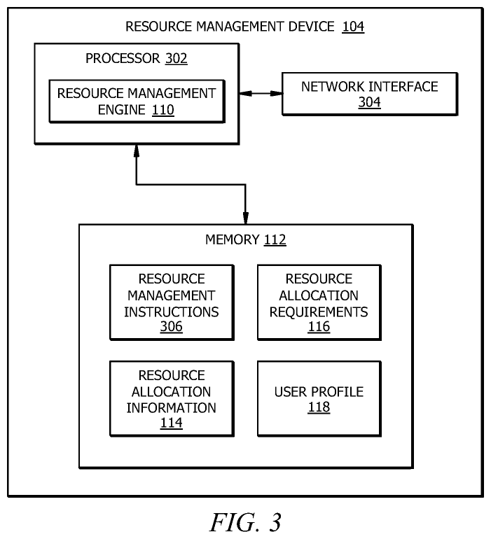

Examples of a resource management device 104 include, but are not limited to, a server, a computer, a database, or any other suitable type of network device. In one embodiment, a resource management device 104 comprises a resource management engine 110 and a memory 112. Additional details about the hardware configuration of the resource management device 104 are described in FIG. 3. The memory 112 is configured to store resource allocation information 114, resource allocation requirements 116, user profiles 118, and/or any other suitable type of data.

In one embodiment, the resource management engine 110 is generally configured to track and manage resource allocations among users in the computer system 100. For example, the resource management engine 110 may be configured to receive information about a resource that a user would like to exchange for access to another resource. Examples of resources include, but are not limited to, hardware resources, software resources, network resources, memory resources, a currency, a property, a physical object, a digital object, or any other suitable type of resource. In this example, the resource management engine 110 is configured to use resource allocation requirements 116 to determine whether the user is approved to exchange a resource for another resource. At a later time, the user can recover their original resource by returning the resource that they borrowed. The resource management engine 110 is configured to monitor and determine when a borrowed resource has been returned to release the resource that was originally provided by the user back to the user. An example of the resource management engine 110 performing this operation is described in more detail in FIG. 2.

The resource allocation information 114 generally comprises information that identifies resources that are available to be allocated to users and resources that are currently allocated to users. The resource allocation requirements 116 generally comprise rules for determining whether a user qualifies for a resource. Each user profile 118 is uniquely associated with a user and generally comprises information that is associated with resources that are currently owned or allocated to the user. For example, a user profile 118 may identify a user, any resources that are allocated to the user, and corresponding resources they have exchanged for access to other resources.

### Database

Examples of a database 106 include, but are not limited to, file repositories, computers, databases, memories, servers, shared folders, or any other suitable type of networking device. In some embodiments, the database 106 may be configured to store resource allocation information 114, resource allocation requirements 116, user profiles 118, and/or any other suitable type of information that is associated with the computer system 100. In this case, the resource management device 104 may request information from the database 106 or store information in the database 106. In FIG. 1, the computer system 100 shows a single database 106. In other embodiments, the computer system 100 may comprise any other suitable number of databases 106. In some embodiments, the database 106 may be optional and omitted.

### Resource Allocating Process

FIG. 2 is a flowchart of an embodiment of a resource allocating process 200. The computer system 100 may employ process 200 to allow users to request access to resources within the computer system 100 by exchanging control of resources that they currently own or are associated with. Process 200 allows the computer system 100 to use a centralized repository to track and manage resource allocations among its users. This process provides improved resource utilization and management compared to other systems that use a distributed approach where information about resources is stored in multiple locations.

In one embodiment, before allocating resources to a user, the resource management device 104 may first collect information about a user and the resources that they currently own or are assigned. For example, the resource management device 104 may populate a user profile 118 with contact information for a user, demographic information for a user, account information for a user, one or more resource identifiers, information associated with each resource, and/or any other suitable type of information that is associated with a user and their resources. After the user profile 118 is populated, the resource management device 104 stores and maintains the information in the user profile 118 so that it can be accessed at a later time when a user requests access to a new resource.

For example, after populating user profiles 118 for users, the resource management device 104 will monitor the computer system 100 for resource requests 120 from a user to exchange one resource for another resource. For instance, a user may generate and send a resource request 120 to the resource management device 104 via an application in their network device 102 (e.g. computer or smartphone). In other examples, a representative can generate and send the resource request 120 via their network device 102 on behalf of a user.

At operation 202, the resource management device 104 receives a resource request 120 for a user. In one embodiment, the resource request 120 identifies a user, a first resource that is currently assigned or owned by the user, and a second resource that the user is requesting access to. The first resource and the second resource may be hardware resources, software resources, network resources, memory resources, a currency, a property, a physical object, a digital object, or any other suitable type of resource. As an example, the resource request 120 may comprise a user identifier for a user, a first identifier for a first resource that corresponds with a piece of equipment (e.g. a device or a vehicle), and a second identifier for a second resource. The second identifier may identify another piece of equipment, a currency, or any other suitable type of resource that the user would like to access. In some embodiments, the resource request 120 may further comprise a resource type identifier that indicates a classification type for the first resource. Examples of resource types include, but are not limited to, hardware resource, software resource, a property, currency, equipment, vehicle, intellectual property, digital object, physical object, or any other suitable type of classification.

At operation 204, the resource management device 104 obtains information associated with the first resource for the user. Here, the resource management device 104 first identifies a user profile 118 that is associated with the user. For example, the resource management device 104 may use the user identifier from the resource request 120 as a search token to identify a corresponding user profile 118 from memory 112 that is associated with the user. After identifying the user profile 118 that is associated with the user, the resource management device 104 may then identify information from within the user profile 118 that is associated with the first resource. For example, the resource management device 104 may use the identifier from the resource request 120 that corresponds with the first resource to identify information within the user profile 118 that is associated with the first resource. The information that is associated with the first resource may comprise a description, a reference number, product information (e.g. a model number or serial number), a physical address, ownership information, historical information, a value (e.g. currency value), documentation, or any other suitable type of information that is associated with the first resource.

At operation 206, the resource management device 104 determines whether to obtain additional information about the first resource. In some instances, the resource management device 104 may require information about the first resource that is not available in the user profile 118. In this case, the resource management device 104 will determine what information is available in the user profile 118 and then will make a determination about whether additional information is necessary for processing the resource request 120. Examples of additional information may include, but are not limited to, protection or insurance policy information, a valuation, Uniform Commercial Code or lien information, usage history, ownership history, or any other suitable type of information that is associated with the first resource. In some embodiments, the resource management device 104 may determine to obtain additional information about the first resource based on the resource type of the first resource. In this case, certain resource types may be used as triggers to indicate that additional information is needed for a resource. For example, when the first resource has a resource type that corresponds with equipment or a property, the resource management device 104 may determine to obtain additional information such as insurance policy information, a valuation, and/or ownership history for the first resource. In other examples, the resource management device 104 may determine to obtain any other suitable type of additional information for any other resource types.

The resource management device 104 proceeds to operation 208 in response to determining to obtain additional information about the first resource. At operation 208, the resource management device 104 obtains additional information associated with the first resource. In this case, the resource management device 104 sends a request for additional information about the first resource. For example, the resource management device 104 may send a request to the user for additional information about the first resource. In other examples, the resource management device 104 may send a request to a representative, a third party, or a database to request additional information about the first resource.

Returning to operation 206, the resource management device 104 proceeds to operation 210 in response to determining not to obtain additional information for the first resource. In this case, the resource management device 104 determines that no additional information is required for deciding on whether to allocate the second resource to the user. At operation 210, the resource management device 104 determines whether to allocate the second resource to the user. Here, the resource management device 104 uses the resource allocation requirements 116 with the collected information about the first resource that was obtained in operations 204 and 208 to determine whether to allocate the second resource to the user. For example, the resource allocation requirements 116 may specify that the value of the first resource should be greater than or equal to the value of the second resource before allocating the second resource to the user. In this example, the resource management device 104 determines whether to allocate the second resource to the user based on the value of the first resource and the second resource. For instance, the resource management device 104 may first determine a first value that is associated with the first resource and a second value that is associated with the second resource. The resource management device 104 may then determine the user qualifies for the second resource when the first value that is associated with the first resource is greater than or equal to the second value that is associated with the second resource.

As another example, the resource allocation requirements 116 may specify certain types of information for the first resource that should be in place before allocating the second resource to the user. For instance, the resource allocation requirements 116 may specify that a protection or insurance policy should be active for the first resource. In this example, the resource management device 104 may use the information that is associated with the first resource to determine whether a protection or insurance policy is currently active. In other examples, the the resource allocation requirements 116 may specify any other suitable type or combination of information that is required before allocating the second resource to the user. In some examples, the resource management device 104 may request assistance or approval from a representative before determining to allocate the second resource to the user.

The resource management device 104 terminates process 200 in response to determining not to allocate the second resource to the user. In this case, the resource management device 104 determines that the first resource does not qualify the user to access the second resource. Here, the resource management device 104 may send a notification to the user or their representative that indicates that the first resource does not qualify the user to access the second resource.

The resource management device 104 proceeds to operation 212 in response to determining to allocate the second resource to the user. In this case, the resource management device 104 begins the process of exchanging the first resource from the user for access to the second resource. At operation 212, the resource management device 104 obtains the first resource from the user. Here, the resource management device 104 temporarily assumes ownership of the first resource. In other words, obtaining the first resource from the user temporarily suspends the user from owning or accessing the first resource. In some examples, the resource management device 104 may temporarily take physical ownership of the first resource. In other examples, the resource management device 104 may obtain the first resource by establishing a contract or lien against the first resource. After obtaining the first resource, the resource management device 104 may document the change in ownership or control in the user profile 118 and/or resource allocation information 114.

At operation 214, the resource management device 104 associates the second resource with the user. After obtaining the first resource, the resource management device 104 associates the second resource with the user for a predetermined period of time. The predetermined period of time may be an hour, a day, a month, six months, a year, fours years, or any other suitable amount of time. For example, the resource management device 104 may associate the second resource with the user by creating an entry for the association in user profile 118 and/or the resource allocation information 114. The resource management device 104 may also specify any other terms or conditions that are associated with returning the second resource and/or retrieving the first resource in the user profile 118 and/or the resource allocation information 114.

At operation 216, the resource management device 104 determines whether the second resource has been returned within the predetermined period of time. Here, the resource management device 104 periodically monitors the status of the second resource to determine whether the second resource has been returned. The user may physically or digitally return the second resource to the resource management device 104. The resource management device 104 remains at operation 216 in response to determining that the user has not returned the second resource. In this case, the resource management device 104 remains at operation 216 to continue monitoring the status of the second resource to determine when the user has returned the second resource. Otherwise, the resource management device 104 proceeds to operation 218 in response to determining that the user has returned the second resource. In this case, the resource management device 104 proceeds to operation 218 to begin the process of releasing the first resource back to the user.

In some embodiments, the resource management device 104 may also check whether any other resources have been allocated to the user in exchange for the first resource before releasing the first resource back to the user. In some instances, the user may request access to multiple resources in exchange for the first resource. In this case, the resource management device 104 checks the user profile 118 and/or resource allocation information 114 to determine whether there are any other resources are currently allocated to the user in exchange for the first resource. When there are other resources allocated to the user, the resource management device 104 will verify that the other resources have also been returned before proceeding to operation 218.

At operation 218, the resource management device 104 removes the association between the second resource and the user. Here, the resource management device 104 may remove the association between the second resource and the user from the user profile 118 and/or the resource allocation information 114. Removing the association between the second resource and the user indicates that the user has successfully returned the second resource.

At operation 220, the resource management device 104 releases the first resource back to the user. After determining that the user has successfully returned the second resource, the resource management device 104 passes the ownership or control of the first resource back to the user. By releasing the first resource to the user, the resource management device 104 removes the temporary suspension of the user from owning or accessing the first resource. The resource management device 104 may document the change in ownership or control in the user profile 118 and/or resource allocation information 114.

### Hardware Configuration for the Resource Management Device

FIG. 3 is an embodiment of a resource management device 104 for the computer system 100. As an example, the resource management device 104 may be a server or a computer. The resource management device 104 comprises a processor 302, a memory 112, and a network interface 304. The resource management device 104 may be configured as shown or in any other suitable configuration.

### Processor

The processor 302 is a hardware device that comprises one or more processors operably coupled to the memory 112. The processor 302 is any electronic circuitry including, but not limited to, state machines, one or more central processing unit (CPU) chips, logic units, cores (e.g. a multi-core processor), field-programmable gate array (FPGAs), application-specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 112 and the network interface 304. The one or more processors are configured to process data and may be implemented in hardware or software. For example, the processor 302 may be 8-bit, 16-bit, 32-bit, 64-bit, or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute resource management instructions 306 to implement the resource management engine 110. In this way, processor 302 may be a special-purpose computer designed to implement the functions disclosed herein. In an embodiment, the resource management engine 110 is implemented using logic units, FPGAs, ASICs, DSPs, or any other suitable hardware. The resource management engine 110 is configured to operate as described in FIGS. 1 and 2. For example, the resource management engine 110 may be configured to perform the operations of process 200 as described in FIG. 2.

### Memory

The memory 112 is a hardware device that is operable to store any of the information described above with respect to FIGS. 1 and 2 along with any other data, instructions, logic, rules, or code operable to implement the function(s) described herein when executed by the processor 302. The memory 112 comprises one or more disks, tape drives, or solid-state drives, and may be used as an over-flow data storage device, to store programs when such programs are selected for execution, and to store instructions and data that are read during program execution. The memory 112 may be volatile or non-volatile and may comprise a read-only memory (ROM), random-access memory (RAM), ternary content-addressable memory (TCAM), dynamic random-access memory (DRAM), and static random-access memory (SRAM).

The memory 112 is operable to store resource management instructions 306, resource allocation information 114, resource allocation requirements 116, user profiles 118, and/or any other data or instructions. The resource management instructions 306 may comprise any suitable set of instructions, logic, rules, or code operable to execute the resource management engine 110. The resource allocation information 114, the resource allocation requirements 116, and the user profiles 118 are configured similar to the resource allocation information 114, the resource allocation requirements 116, and the user profiles 118 described in FIGS. 1 and 2, respectively.

### Network Interface

The network interface 304 is a hardware device that is configured to enable wired and/or wireless communications. The network interface 304 is configured to communicate data between network devices 102, databases 106, and other devices, systems, or domains. For example, the network interface 304 may comprise an NFC interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processor 302 is configured to send and receive data using the network interface 304. The network interface 304 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A resource management device, comprising:
a memory operable to store:
a plurality of user profiles, wherein each user profile comprises information associated with resources that are currently owned by a user;
resource allocation information that identifies resources that are available; and
resource allocation requirements comprising rules for determining whether a user qualifies for a resource; and
a processor operably coupled to the memory, configured to;
receive a resource request, wherein the resource request identifies:
a first user;
a first resource that is currently assigned to the first user; and
a second resource that the first user is requesting;
obtain information for the first resource from a first user profile that is associated with the first user;
determine the first user qualifies for the second resource based on the information associated with the first resource and the resource allocation requirements for the second resource;
obtain the first resource from the first user, wherein obtaining the first resource temporarily suspends the first user from owning the first resource;
associate the second resource with the first user for a predetermined period of time;
determine the first user has returned the second resource within the predetermined period of time;
remove the association between the second resource and the first user in response to determining that the first user has returned the second resource; and
release the first resource to the first user, wherein releasing the first resource to the first user removes the temporary suspension of the first user from owning the first resource.

2. The device of claim 1, wherein:
the resource request further identifies a resource type for the first resource;
the processor is further configured to:
request additional information for the first resource based on the resource type of the first resource;
determining the first user qualifies for the second resource is based at least in part on the additional information for the first resource.

3. The device of claim 1, wherein the information for the first resource comprises a value that is associated with the first resource.

4. The device of claim 1, wherein:
the processor is further configured to determine the first user is not associated with any other resources in the resource allocation information; and
releasing the first resource to the first user is based at least in part on determining that the first user is not associated with any other resources in the resource allocation information.

5. The device of claim 1, wherein determining the first user qualifies for the second resource comprises:
determining a first value for the first resource;
determining a second value for the second resource; and
determining that the first value is greater than or equal to the second value.

6. The device of claim 1, wherein the first resource is a physical object.

7. The device of claim 1, wherein the first resource is a digital object.

8. A resource allocating method, comprising:
receiving a resource request, wherein the resource request identifies:
a first user;
a first resource that is currently assigned to the first user; and
a second resource that the first user is requesting;
obtaining information for the first resource from a first user profile that is associated with the first user;
determining the first user qualifies for the second resource based on the information associated with the first resource and resource allocation requirements for the second resource, wherein the resource allocation requirements comprises rules for determining whether a user qualifies for a resource;
obtaining the first resource from the first user, wherein obtaining the first resource temporarily suspends the first user from owning the first resource;
associating the second resource with the first user for a predetermined period of time;
determining the first user has returned the second resource within the predetermined period of time;
removing the association between the second resource and the first user in response to determining that the first user has returned the second resource; and
releasing the first resource to the first user, wherein releasing the first resource to the first user removes the temporary suspension of the first user from owning the first resource.

9. The method of claim 8, further comprising:
identifying a resource type for the first resource;
requesting additional information for the first resource based on the resource type of the first resource; and
wherein determining the first user qualifies for the second resource is based at least in part on the additional information for the first resource.

10. The method of claim 8, wherein the information for the first resource comprises a value that is associated with the first resource.

11. The method of claim 8, further comprising:
determining the first user is not associated with any other resources in the resource allocation information; and
wherein releasing the first resource to the first user is based at least in part on determining that the first user is not associated with any other resources in the resource allocation information.

12. The method of claim 8, wherein determining the first user qualifies for the second resource comprises:
determining a first value for the first resource;
determining a second value for the second resource; and
determining that the first value is greater than or equal to the second value.

13. The method of claim 8, wherein the first resource is a physical object.

14. The method of claim 8, wherein the first resource is a digital object.

15. A computer program product comprising executable instructions stored in a non-transitory computer-readable medium that when executed by a processor causes the processor to:
receive a resource request, wherein the resource request identifies:
a first user;
a first resource that is currently assigned to the first user; and
a second resource that the first user is requesting;
obtain information for the first resource from a first user profile that is associated with the first user;
determine the first user qualifies for the second resource based on the information associated with the first resource and resource allocation requirements for the second resource, wherein the resource allocation requirements comprise rules for determining whether a user qualifies for a resource;
obtain the first resource from the first user, wherein obtaining the first resource temporarily suspends the first user from owning the first resource;
associate the second resource with the first user for a predetermined period of time;
determine the first user has returned the second resource within the predetermined period of time;
remove the association between the second resource and the first user in response to determining that the first user has returned the second resource; and
release the first resource to the first user, wherein releasing the first resource to the first user removes the temporary suspension of the first user from owning the first resource.

16. The computer program product of claim 15, further comprising instructions that when executed by the processor causes the processor to:
identify a resource type for the first resource;
request additional information for the first resource based on the resource type of the first resource; and
wherein determining the first user qualifies for the second resource is based at least in part on the additional information for the first resource.

17. The computer program product of claim 15, wherein the information for the first resource comprises a value that is associated with the first resource.

18. The computer program product of claim 15, further comprising instructions that when executed by the processor causes the processor to:
determine the first user is not associated with any other resources in the resource allocation information; and
wherein releasing the first resource to the first user is based at least in part on determining that the first user is not associated with any other resources in the resource allocation information.

19. The computer program product of claim 15, wherein determining the first user qualifies for the second resource comprises:
determining a first value for the first resource;
determining a second value for the second resource; and
determining that the first value is greater than or equal to the second value.

20. The computer program product of claim 15, wherein the first resource is a physical object.
